(19) United States
(12) Patent Application Publication
(10) Pub. No.: US 2013/0278753 A1
(43) Pub. Date: Oct. 24, 2013

(54) Specialty GAS Detection Method and Specialty GAS Detection Cart Implementing Same

(71) Applicants: Zhenhua Guo, Shenzhen City (CN); Chunhao Wu, Shenzhen City (CN); Kunhsien Lin, Shenzhen City (CN); Erqing Zhu, Shenzhen City (CN); Yongqiang Wang, Shenzhen City (CN); Yunshao Jiang, Shenzhen City (CN); Xiande Li, Shenzhen City (CN); Weibing Yang, Shenzhen City (CN); Zenghong Chen, Shenzhen City (CN); Minghu Qi, Shenzhen City (CN)

(72) Inventors: Zhenhua Guo, Shenzhen City (CN); Chunhao Wu, Shenzhen City (CN); Kunhsien Lin, Shenzhen City (CN); Erqing Zhu, Shenzhen City (CN); Yongqiang Wang, Shenzhen City (CN); Yunshao Jiang, Shenzhen City (CN); Xiande Li, Shenzhen City (CN); Weibing Yang, Shenzhen City (CN); Zenghong Chen, Shenzhen City (CN); Minghu Qi, Shenzhen City (CN)

(73) Assignee: Shenzhen China Star Optoeletronics Technology Co., Ltd., Shenzhen City, Guangdong (CN)

(21) Appl. No.: 13/515,263

(22) PCT Filed: Apr. 25, 2012
(86) PCT No.: PCT/CN12/74630

§ 371 Date: Jun. 11, 2012

(30) Foreign Application Priority Data
Apr. 19, 2012 (CN) 201210118287.9

(51) Int. Cl. G08B 21/14; B60R 16/02; H04N 7/18; B60L 11/00

(52) U.S. Cl. 348/114; 180/65.1; 340/870.02

(57) ABSTRACT

The present invention provides a specialty gas detection method and a specialty gas detection cart for implementing the method. The method includes (1) providing a specialty gas detection cart and a control station; (2) connecting the control station and the specialty gas detection cart to each other in a wireless manner; (3) the specialty gas detector collecting gas information from the environment where the detector is located and transmitting the collected gas information to the data processor to allow the data processor to process the gas information and transmit the result of processing of the gas information via the first wireless transceiver device to the control station; and (4) the control station receiving the result of processing of the gas information and displaying the result of processing of the gas information. Remote monitoring of a specialty gas leakage site can thus be made through the specialty gas detection cart.

### BACKGROUND OF THE INVENTION

1. Field of the Invention

The present invention relates to the field of production safety, and in particular to a specialty gas detection method and a specialty gas detection cart implementing the method.

2. The Related Arts

Based on the property, gases are generally classified to two categories, namely bulk gas and specialty gas. The bulk gas, such as N₂ and clean dry air (CDA), is generally of a large amount of consumption, while the specialty gas, such as SiH₄ and NF₃, is generally used in a small amount but may be dangerous to human lives with an extremely minor amount.

A liquid crystal panel workshop includes various facilities that consume specialty gases. To avoid unexpected events of for example leakage during the supply and use of the specialty gases, a gas monitoring system (GMS) is often installed in the liquid crystal panel workshop and handheld gas detectors are deployed in the manufacture sites to monitor gas information. Once leakage of specialty gases occurs, security report is immediately issued in order to effect emergency evacuation of the manufacture site. Then, professional persons wearing protection equipment are sent to the manufacture site for handling.

However, the conventionally used gas monitoring system and the handheld gas detectors are only capable of detecting fixed sites and provide a limited area of detection so that they do not generally meet the needs for overall area detection. For any events of specialty gas leakage, it might take the professional handling person excessively long time to reach the leakage spot to carry out necessary handling. This inevitably increases the risk of safety and is also adverse to timely handling of the events.

### SUMMARY OF THE INVENTION

Thus, an object of the present invention is to provide a specialty gas detection method, which employs remote controlling of a specialty gas detection cart to effect remote monitor of a specialty gas leakage site in order to shorten the time period that an operator is exposed to the leakage site and the reduce the risk of safety.

Another object of the present invention is to provide a specialty gas detection cart, which has a simple structure, has great flexibility of movement, and is easy to operate.

To achieve the objects, the present invention provides a specialty gas detection method, comprising the following steps:

Step 1: providing a specialty gas detection cart and a control station, wherein the specialty gas detection cart comprises a cart body, a data processor mounted on the cart body, a specialty gas detector mounted to the cart body and electrically connected to the data processor, a first wireless transceiver device electrically connected to the data processor, and a power supply mounted to the cart body, the power supply being electrically connected to the data processor, the specialty gas detector, and the first wireless transceiver device;

Step 2: connecting the control station and the specialty gas detection cart to each other in a wireless manner;

Step 3: the specialty gas detector collecting gas information from the environment where the detector is located and transmitting the collected gas information to the data processor to allow the data processor to process the gas information and transmit the result of processing of the gas information via the first wireless transceiver device to the control station; and

Step 4: the control station receiving the result of processing of the gas information and displaying the result of processing of the gas information.

The cart body comprises a chassis, a wheel assembly attached to the chassis, and electrical machines mounted inside the chassis to drive the wheel assembly to rotate. The electrical machines are electrically connected to the power supply.

The control station transmits a control signal to the data processor and the data processor responds to the control signal to control operation of the wheel assembly.

The operation of the wheel assembly comprises advancing, reversing, turning, and braking.

The specialty gas detection cart comprises a camera device mounted to the cart body and electrically connected to the data processor.

The specialty gas detection method further comprises Step 5 in which the camera device picks up images of the environment where the camera device is located and transmitting the images of environment to the data processor to allow the data processor to process the images of environment and transmits the result of processing of the images of environment via the first wireless transceiver device to the control station; and

Step 6 in which the control station receives the result of processing of the images of environment and displays the result of processing of the images of environment.

The camera device comprises a rotatable wide-angle camera.

The control station comprises a station body, a controller mounted on the station body, a second wireless transceiver device electrically connected to the controller, and a display device electrically connected to the controller.

The present invention also provides a specialty gas detection cart, which comprises a cart body, a data processor mounted on the cart body, a specialty gas detector mounted to the cart body and electrically connected to the data processor, a first wireless transceiver device electrically connected to the data processor, and a power supply mounted to the cart body. The power supply is electrically connected to the data processor, the specialty gas detector, and the first wireless transceiver device.

The cart body comprises a chassis, a wheel assembly attached to the chassis, and electrical machines mounted inside the chassis to drive the wheel assembly to rotate. The electrical machines are electrically connected to the power supply. The specialty gas detection cart comprises a camera device mounted to the cart body and electrically connected to the data processor. The camera device comprises a rotatable wide-angle camera.

The efficacy of the present invention is that the present invention provides a specialty gas detection method. The specialty gas detection method of the present invention, through the use of a specialty gas detection cart, allows a control station to effect remote monitoring of a specialty gas leakage site via the specialty gas detection cart, whereby concerned people may acquire are more information as possible before they enter the event site thereby shortening the time period for handling the event and preventing the event from getting severer. The present invention also provides a specialty gas detection cart, which timely and precisely feeds information of an event site back to a control station through a specialty gas detector, a wireless transceiver module, and a rotatable camera mounted on a body thereof and has a simple structure, has great flexibility of movement, and is easy to operate.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, will be apparent from the following detailed description of an embodiment of the present invention, with reference to the attached drawings. In the drawings:

FIG. 1 is a flow chart illustrating a specialty gas detection method according to the present invention;

FIG. 2 is a block diagram showing a control station and a specialty gas detection cart that carry out the specialty gas detection method according to the present invention; and

FIG. 3 is a perspective view showing the specialty gas detection cart according to the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

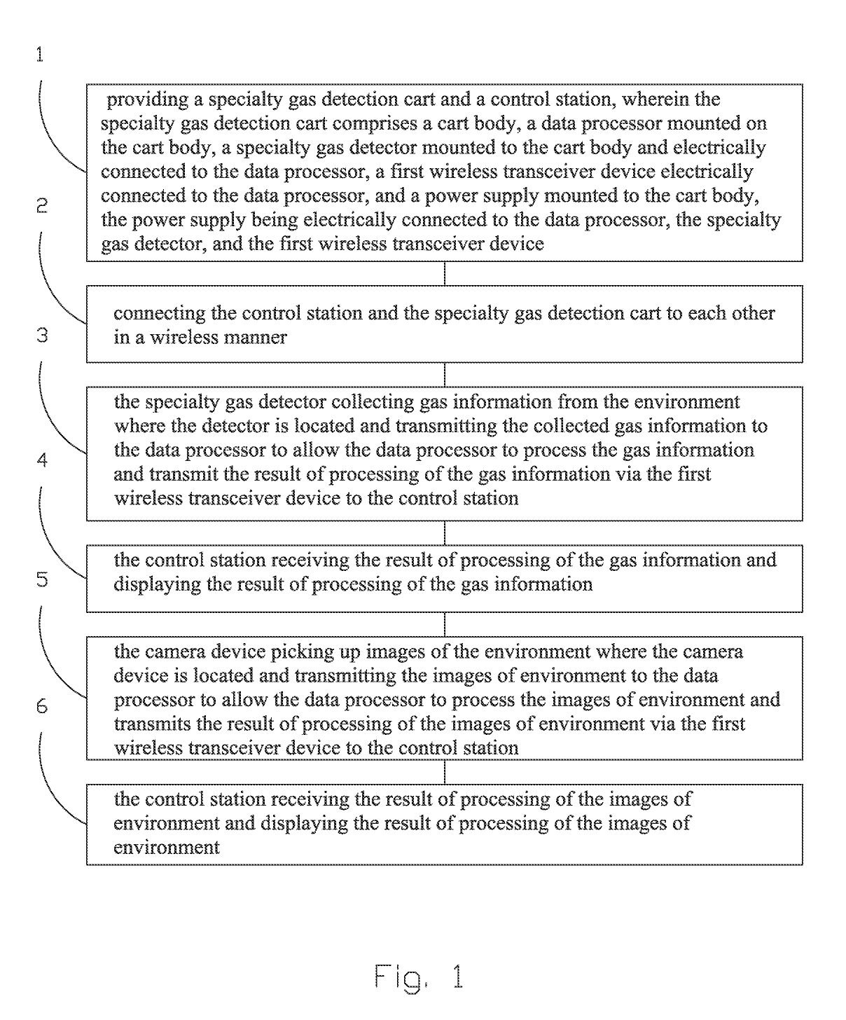

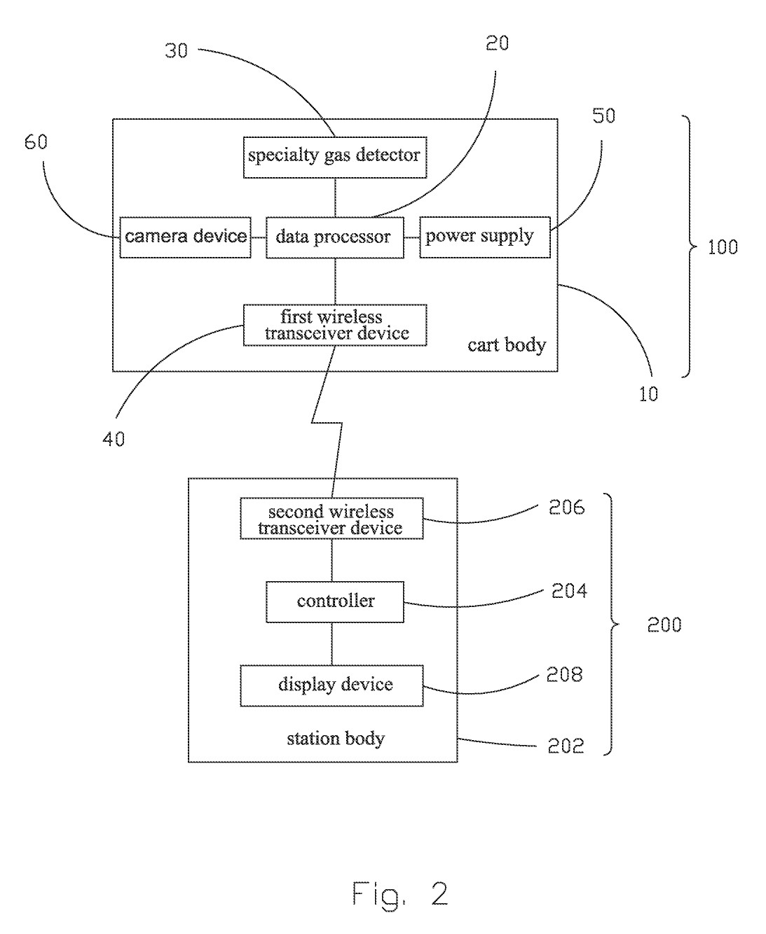

Referring to FIGS. 1-3, the present invention provides a specialty gas detection method, which comprises the following steps:

Step 1: providing a specialty gas detection cart 100 and a control station 200, wherein the specialty gas detection cart 100 comprises a cart body 10, a data processor 20 mounted on the cart body 10, a specialty gas detector 30 mounted to the cart body 10 and electrically connected to the data processor 20, a first wireless transceiver device 40 electrically connected to the data processor 20, and a power supply 50 mounted to the cart body. The power supply 50 is electrically connected to the data processor 20, the specialty gas detector 30, and the first wireless transceiver device 40 in order to supply operation power to the data processor 20, the specialty gas detector 30, and the first wireless transceiver device 40.

The cart body 10 comprises a chassis 12, a wheel assembly 14 attached to the chassis 12, and electrical machines (not shown) mounted inside the chassis 12 to drive the wheel assembly 14 to rotate. The electrical machines are electrically connected to the power supply 50.

The data processor 20, the specialty gas detector 30, the first wireless transceiver device 40, and the power supply 50 are all mounted on the chassis 12. The actual locations thereof can be adjusted as desired without affecting the actual functions of the specialty gas detection cart 100.

The specialty gas detection cart 100 further comprises a camera device 60 that is mounted to the cart body 10 and electrically connected to the data processor 20. Preferably, the camera device 60 is a rotatable wide-angle camera, which expands the photographing angle in order to pick up more complete environmental information to thereby more precisely identify the location where gas abnormality occurs.

The control station 200 comprises a station body 202, a controller 204 mounted on the station body 202, a second wireless transceiver device 206 electrically connected to the controller 204, and a display device 208 electrically connected to the controller 204.

Step 2: connecting the control station 200 and the specialty gas detection cart 100 to each other in a wireless manner.

The controller 204 of the control station 200 transmits via the second wireless transceiver device 206 a connection request signal, and the data processor 20 of the specialty gas detection cart 100 responds to the connection request signal and controls the first wireless transceiver device 40 to establish wireless connection with the second wireless transceiver device 206.

Step 3: the specialty gas detector 30 collecting gas information from the environment where the detector is located and transmitting the collected gas information to the data processor 20 to allow the data processor 20 to process the gas information and transmit the result of processing of the gas information via the first wireless transceiver device 40 to the control station 200.

Step 4: the control station 200 receiving the result of processing of the gas information and displaying the result of processing of the gas information.

The second wireless transceiver device 206 of the control station 200 receives the result of processing of the gas information and transmits the result of processing of the gas information to the controller 204. The controller 204 in turn controls the display device 208 to display the result of processing of the gas information.

Step 5: the camera device 60 picking up images of the environment where the camera device is located and transmitting the images of environment to the data processor 20 to allow the data processor 20 to process the images of environment and transmits the result of processing of the images of environment via the first wireless transceiver device 40 to the control station 200.

Step 6: the control station 200 receiving the result of processing of the images of environment and displaying the result of processing of the images of environment.

The second wireless transceiver device 206 of the control station 200 receives the result of processing of the images of environment and transmits the result of processing of the images of environment to the controller 204. The controller 204 in turn controls the display device 208 to display the result of processing of the images of environment.

Steps 5 and 6 may be alternatively performed in front of Steps 3 and 4 as desired. The specialty gas detection method of the instant embodiment is applicable to detecting specialty gas in a liquid crystal panel workshop.

In the operation, the control station 200 transmits an activation control signal via the second wireless transceiver device 206 to the first wireless transceiver device 40. The first wireless transceiver device 40 receives the activation control signal and transmits the activation control signal to the data processor 20. The data processor 20, in response to the activation control signal, controls the operations of the wheel assembly 14 of the detection cart 100. The operations of the wheel assembly 14 include advancing, reversing, turning, and braking. The control station 200 transmits a collection control signal via the second wireless transceiver device 206 to the first wireless transceiver device 40. The first wireless transceiver device 40 receives the collection control signal and transmits the collection control signal to the data processor 20. The data processor 20, in response to the collection control signal, controls the specialty gas detector 30 of the detection cart 100 to collect gas information. The specialty gas detector 30, after collecting the gas information, transmits the gas information to the data processor 20. The data processor 20 carries out simple processing of the gas information (such as classification, computation of concentration and the likes) and then transmits the result of processing of the gas information via the first wireless transceiver device 40 to the second wireless transceiver device 206 of the control station 20. The second wireless transceiver device 206 receives the result of processing of the gas information and transmits the result of processing of the gas information to the controller 204. The controller 204 receives the result of processing of the gas information and displays the result of processing of the gas information via the display device 208, whereby concerned people may acquire as more information as possible before they enter the event site thereby shortening the time period for handling the event and reducing the risk of safety.

The present invention provides a specialty gas detection method. The specialty gas detection method of the present invention, through the use of a specialty gas detection cart, allows a control station to effect remote monitoring of a specialty gas leakage site via the specialty gas detection cart, whereby concerned people may acquire are more information as possible before they enter the event site thereby shortening the time period for handling the event and preventing the event from getting severer.

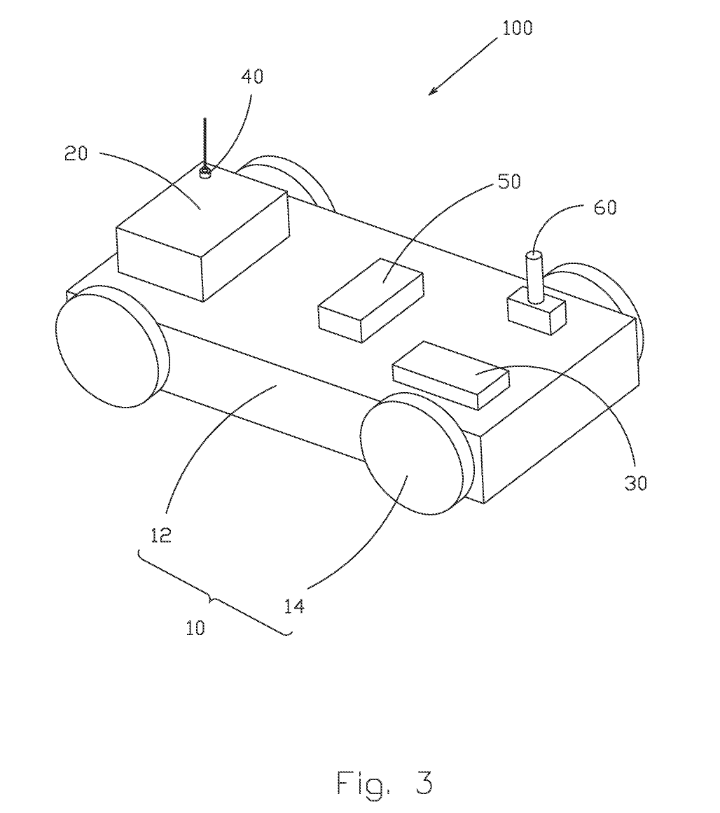

Referring to FIG. 3, the present invention also provides a specialty gas detection cart 100, which comprises a cart body 10, a data processor 20 mounted on the cart body 10, a specialty gas detector 30 mounted to the cart body 10 and electrically connected to the data processor 20, a first wireless transceiver device 40 electrically connected to the data processor 20, and a power supply 50 mounted to the cart body. The power supply 50 is electrically connected to the data processor 20, the specialty gas detector 30, and the first wireless transceiver device 40 in order to supply operation power to the data processor 20, the specialty gas detector 30, and the first wireless transceiver device 40.

The cart body 10 comprises a chassis 12, a wheel assembly 14 attached to the chassis 12, and electrical machines (not shown) mounted inside the chassis 12 to drive the wheel assembly 14 to rotate. The electrical machines are electrically connected to the power supply 50.

The data processor 20, the specialty gas detector 30, the first wireless transceiver device 40, and the power supply 50 are all mounted on the chassis 12. The actual locations thereof can be adjusted as desired without affecting the actual functions of the specialty gas detection cart 100.

The specialty gas detection cart 100 further comprises a camera device 60 that is mounted to the cart body 10 and electrically connected to the data processor 20 for picking up environmental information. In the instant embodiment, the camera device 60 is a rotatable wide-angle camera, which expands the photographing angle in order to pick up more complete environmental information to thereby more precisely identify the location where gas abnormality occurs. The specialty gas detection method of the instant embodiment is applicable to detecting specialty gas in a liquid crystal panel workshop.

In summary, the present invention provides a specialty gas detection cart, which timely and precisely feeds information of an event site back to a control station through a specialty gas detector, a wireless transceiver module, and a rotatable camera mounted on a body thereof and has a simple structure, has great flexibility of movement, and is easy to operate.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A specialty gas detection method, comprising the following steps:
Step 1: providing a specialty gas detection cart and a control station, wherein the specialty gas detection cart comprises a cart body, a data processor mounted on the cart body, a specialty gas detector mounted to the cart body and electrically connected to the data processor, a first wireless transceiver device electrically connected to the data processor, and a power supply mounted to the cart body, the power supply being electrically connected to the data processor, the specialty gas detector, and the first wireless transceiver device;
Step 2: connecting the control station and the specialty gas detection cart to each other in a wireless manner;
Step 3: the specialty gas detector collecting gas information from the environment where the detector is located and transmitting the collected gas information to the data processor to allow the data processor to process the gas information and transmit the result of processing of the gas information via the first wireless transceiver device to the control station; and
Step 4: the control station receiving the result of processing of the gas information and displaying the result of processing of the gas information.

2. The specialty gas detection method as claimed in claim 1, wherein the cart body comprises a chassis, a wheel assembly attached to the chassis, and electrical machines mounted inside the chassis to drive the wheel assembly to rotate, the electrical machines being electrically connected to the power supply.

3. The specialty gas detection method as claimed in claim 2, wherein the control station transmits a control signal to the data processor and the data processor responds to the control signal to control operation of the wheel assembly.

4. The specialty gas detection method as claimed in claim 3, wherein the operation of the wheel assembly comprises advancing, reversing, turning, and braking.

5. The specialty gas detection method as claimed in claim 1, wherein the specialty gas detection cart comprises a camera device mounted to the cart body and electrically connected to the data processor.

6. The specialty gas detection method as claimed in claim 5 further comprising the following steps:
Step 5: the camera device picking up images of the environment where the camera device is located and transmitting the images of environment to the data processor to allow the data processor to process the images of environment and transmits the result of processing of the images of environment via the first wireless transceiver device to the control station; and
Step 6: the control station receiving the result of processing of the images of environment and displaying the result of processing of the images of environment.

7. The specialty gas detection method as claimed in claim 5, wherein the camera device comprises a rotatable wide-angle camera.

8. The specialty gas detection method as claimed in claim 1, wherein the control station comprises a station body, a controller mounted on the station body, a second wireless transceiver device electrically connected to the controller, and a display device electrically connected to the controller.

9. A specialty gas detection method, comprising the following steps:
Step 1: providing a specialty gas detection cart and a control station, wherein the specialty gas detection cart comprises a cart body, a data processor mounted on the cart body, a specialty gas detector mounted to the cart body and electrically connected to the data processor, a first wireless transceiver device electrically connected to the data processor, and a power supply mounted to the cart body, the power supply being electrically connected to the data processor, the specialty gas detector, and the first wireless transceiver device;
Step 2: connecting the control station and the specialty gas detection cart to each other in a wireless manner;
Step 3: the specialty gas detector collecting gas information from the environment where the detector is located and transmitting the collected gas information to the data processor to allow the data processor to process the gas information and transmit the result of processing of the gas information via the first wireless transceiver device to the control station;
Step 4: the control station receiving the result of processing of the gas information and displaying the result of processing of the gas information;
Step 5: the camera device picking up images of the environment where the camera device is located and transmitting the images of environment to the data processor to allow the data processor to process the images of environment and transmits the result of processing of the images of environment via the first wireless transceiver device to the control station; and
Step 6: the control station receiving the result of processing of the images of environment and displaying the result of processing of the images of environment;
wherein the cart body comprises a chassis, a wheel assembly attached to the chassis, and electrical machines mounted inside the chassis to drive the wheel assembly to rotate, the electrical machines being electrically connected to the power supply;
wherein the control station transmits a control signal to the data processor and the data processor responds to the control signal to control operation of the wheel assembly, the operation of the wheel assembly comprising advancing, reversing, turning, and braking;
wherein the specialty gas detection cart comprises a camera device mounted to the cart body and electrically connected to the data processor, the camera device comprising a rotatable wide-angle camera; and
wherein the control station comprises a station body, a controller mounted on the station body, a second wireless transceiver device electrically connected to the controller, and a display device electrically connected to the controller.

10. A specialty gas detection cart, comprising a cart body, a data processor mounted on the cart body, a specialty gas detector mounted to the cart body and electrically connected to the data processor, a first wireless transceiver device electrically connected to the data processor, and a power supply mounted to the cart body, the power supply being electrically connected to the data processor, the specialty gas detector, and the first wireless transceiver device.

11. The specialty gas detection cart as claimed in claim 10, wherein the cart body comprises a chassis, a wheel assembly attached to the chassis, and electrical machines mounted inside the chassis to drive the wheel assembly to rotate, the electrical machines being electrically connected to the power supply; and
the specialty gas detection cart comprises a camera device mounted to the cart body and electrically connected to the data processor, the camera device comprising a rotatable wide-angle camera.
